(19) United States
(12) Patent Application Publication
(10) Pub. No.: US 2013/0145506 A1
(43) Pub. Date: Jun. 6, 2013

(54) Systems And Methods For Performing Microscopy At Hyperbaric Pressures

(71) Applicants: Jay B. Dean, Land O'Lakes, FL (US); Dominic P. D'agostino, Tampa, FL (US); Stephen Reimers, Lorton, VA (US); Ramesh K. Dixit, Woodbridge, VA (US)

(72) Inventors: Jay B. Dean, Land O'Lakes, FL (US); Dominic P. D'agostino, Tampa, FL (US); Stephen Reimers, Lorton, VA (US); Ramesh K. Dixit, Woodbridge, VA (US)

(21) Appl. No.: 13/680,724

(22) Filed: Nov. 19, 2012

Related U.S. Application Data
(60) Provisional application No. 61/561,559, filed on Nov. 18, 2011.

(51) Int. Cl. G01Q 60/24

(52) U.S. Cl. CPC G01Q 60/24
USPC 850/9; 850/33

(57) ABSTRACT

In some embodiments, a system for performing microscopy at hyperbaric pressures includes a hyperbaric chamber that defines a sealed interior space, and an imaging system contained within the interior space that is operated from outside of the hyperbaric chamber to image materials within the interior space at hyperbaric pressures.

### CROSS-REFERENCE TO RELATED APPLICATION

This application claims priority to co-pending U.S. Provisional Application Ser. No. 61/561,559, filed Nov. 18, 2011, which is hereby incorporated by reference herein in its entirety.

### NOTICE OF GOVERNMENT-SPONSORED RESEARCH

This invention was made with Government support under Grant N000140510519 awarded by Defense University Research Instrumentation Program (DURIP), Grant N000140610105 awarded by Office of Naval Research (ONR), and Grant N000140210643, awarded by Defense University Research Instrumentation Program (DURIP). The Government has certain rights in the claimed inventions.

### BACKGROUND

Since its development in 1986, atomic force microscopy (AFM) has evolved in design and application. Within the last decade, the use of AFM for biological applications has grown considerably. Combining AFM with fluorescence and/or confocal imaging expanded the functionality, and there are now several commercially-available “hybrid” systems designed for biological samples. The advantages of AFM include superior surface resolution capability and measurement of cell volume, membrane viscoelasticity, receptor-ligand interactions, and nanomanipulation.

The underlying mechanisms that govern disorders associated with changes in barometric pressure such as oxygen toxicity, decompression sickness, and nitrogen narcosis are still largely unknown. Although AFM and fluorescence imaging are attractive choices for observing living cells affected by such disorders, there exists a need to understand how gases at increased atmospheric pressure affect the structure and function of cells and cellular components, such as the plasma membrane and mitochondria. An imaging system capable of use at hyperbaric pressures would enable researchers to develop a fundamental understanding of cellular and molecular effects of oxygen toxicity, nitrogen narcosis, and pressure per se.

Although imaging systems have been developed to perform AFM outside of ambient conditions, none have been designed for studying biological samples at hyperbaric pressures. In addition, there exists no commercially-available fluorescence microscopes designed for use at hyperbaric pressures. This is unfortunate as use of simultaneous AFM and fluorescence microscopy under hyperbaric conditions would enable the study of the effects of gases and pressure on cellular signal transduction (using fluorescence microscopy) and would enable researchers to correlate those signals with AFM measurements of membrane nanostructure and visco-elasticity. With such technology, it is conceivable that researchers would be able to understand how gases of different lipid solubility, and thus narcotic and anesthetic potencies, affect the plasma membrane of cells at hyperbaric pressures.

In view of the foregoing discussion, it can be appreciated that it would be desirable to have a system for performing microscopy, such as AFM and fluorescence microscopy, at hyperbaric pressures.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a left-side perspective view of an embodiment of a system for performing microscopy at hyperbaric pressures.

FIG. 2 is a front perspective view of the system of FIG. 1, illustrating a user accessing a chamber of the system through a front hatch door.

FIG. 3 is a right-side perspective view of the system of FIG. 1.

FIG. 4A is a cross-sectional view of a chamber of the system of FIG. 1, illustrating the location of a swing arm mechanism that is used to mount a rear hatch door of the chamber.

FIG. 4B is a detail view of the swing arm mechanism shown in FIG. 4A.

FIG. 5A is a graph that plots the pressure verses temperature within the hyperbaric chamber during testing.

FIGS. 5B-5D are AFM scans that reveal the effect of the pressure and temperature changes shown in FIG. 5A.

FIG. 6A is a graph that plots the pressure verses temperature within the hyperbaric chamber during further testing.

FIGS. 6B and 6C are AFM scans that reveal the effect of the pressure and temperature changes shown in FIG. 6A.

FIG. 6D includes a scan of a calibration grid while pressurized to 85 psig, and a section analysis that shows subnanometer resolution is maintained.

FIGS. 7A and 7B are AFM scans of hippocampal neurons exposed to HBO₂ (4 ATA O₂) that reveal observed morphological changes.

FIGS. 7C and 7D are height plot and histogram analysis that confirmed a reduction in overall height of neuronal processes due to hyperbaric oxygen.

FIGS. 8A-8D are hyperbaric fluorescence microscopy images of intracellular superoxide anion production in U87 glioblastoma cells exposed to ambient air (A, B), hyperbaric N₂ (C), and hyperbarid oxygen (5 ATA O₂) (D).

FIG. 8E is a graph of fluorescence intensity versus time data from three experiments showing superoxide production in air relative to hyperbaric N₂ and HBO₂.

FIGS. 9A and 9B are fluorescence photomicrographs (10×) of living human fibroblast production of superoxide anion after exposure to 30 minutes of a control and 30 minutes of hyperbaric oxygen (3 ATA O₂), respectively.

FIGS. 9C and 9D are AFM scans (27×27 μm²) of the same cell preparation as FIGS. 9A and 9B that were made to resolve morphology of fibroblast under control conditions and following exposure to 6 ATA of hyperbaric air, respectively.

### DETAILED DESCRIPTION

As described above, it would be desirable to have a system for performing microscopy, such as atomic force microscopy (AFM) and fluorescence microscopy, at hyperbaric pressures. Disclosed herein are examples of such systems and methods. In some embodiments, the systems include a sealed hyperbaric pressure chamber that contains imaging equipment, such as an AFM+fluorescence microscope, that can be used to image materials, such as living cells, at hyperbaric pressures.

In the following disclosure, various embodiments are described. It is to be understood that those embodiments are example implementations of the disclosed inventions and that alternative embodiments are possible. All such embodiments are intended to fall within the scope of this disclosure.

Described herein is the adaptation of AFM and fluorescence microscopy for use inside a sealed hyperbaric pressure chamber. The design of the chamber enables easy use of an imaging system provided within the chamber under ambient conditions, and therefore can be used by investigators unfamiliar with hyperbaric imaging. The imaging system provides a means to study living cells under hyperbaric conditions that occur during HBO₂ therapy and wound healing, as well as pathological conditions of the central nervous system (CNS) and pulmonary O₂ toxicity, decompression sickness, exposure to increased pressure (e.g., intracranial hypertension) as well as the anesthetic potency of gases (e.g., N₂ narcosis, CO₂ toxicity) and the use of pressure per se (e.g., hyperbaric He) as an antagonist against the central affects of anesthetic gases.

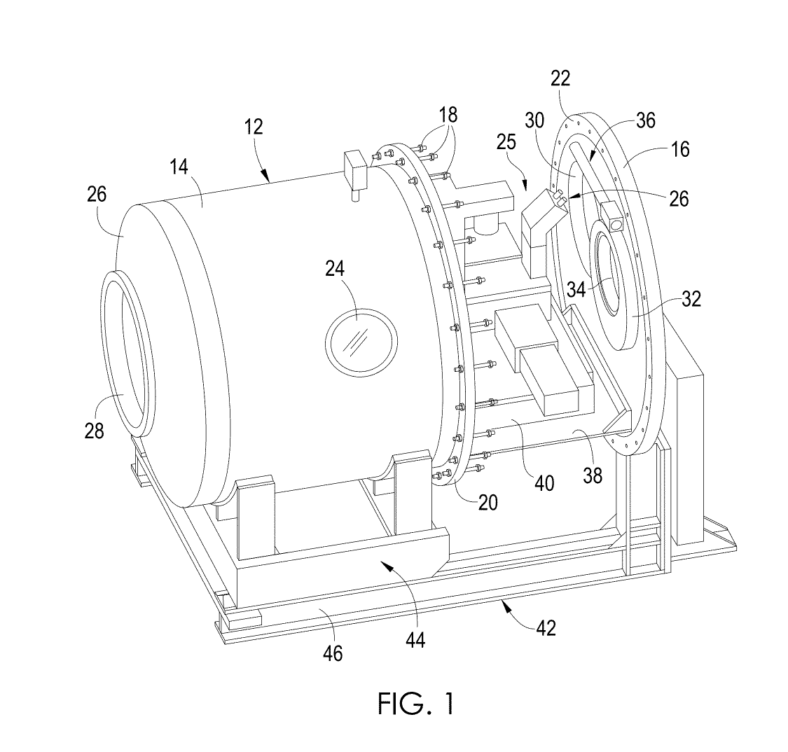

FIGS. 1-4 illustrate an embodiment of a system 10 for performing microscopy at hyperbaric pressures. The system 10 can be used to image substantially any material, but is particularly useful in imaging living biological materials, such as living human cells.

As is shown best in FIGS. 1-3, the system 10 comprises a sealable hyperbaric chamber 12. As used herein, the terms “hyperbaric” and “hyperbaric pressure” refer to elevated pressures that are higher than normal atmospheric pressure. In some embodiments, such pressures are in the range of approximately 0.1 to 85 pounds per square inch gauge (psig). In other embodiments, the pressures range from approximately 10 to 75 psig. By way of example, chamber 12 can be made of steel and weigh approximately 3.25 tons (3000 kg). The chamber 12 generally includes a body 14 and a front wall 16 that can be secured together, for instance using a plurality of bolts 18 that extend though aligned holes provided in a mounting flange 20 of the body and in the outer periphery 22 of the front wall.

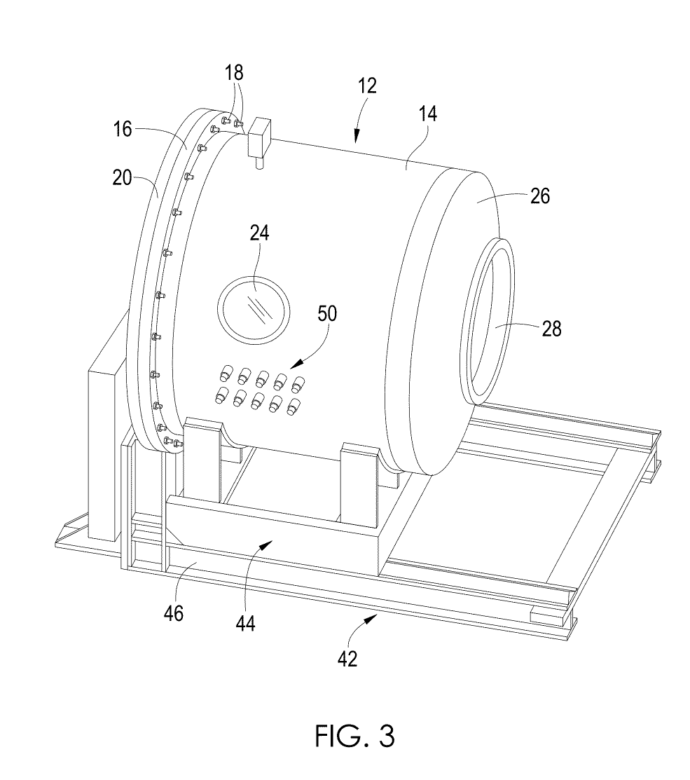

The body 14 is formed as a large vessel having a generally cylindrical shape and a generally round cross-section. In some embodiments, the body 14 can have an outer diameter of approximately 53.25 inches, and the walls of the body can be made of approximately 0.375 inch steel. In such a case, pressures of up to approximately 85 psig can be safely generated within the chamber 12, which is the pressure equivalent of approximately 196 feet of seawater. As is shown in FIGS. 1 and 3, the body 14 can include port windows 24 that enable users to look into an interior space formed by the body.

The front end of the body 14 is open to provide access to the interior space. As is shown in FIG. 1, an imaging system 24 can be provided within the interior space in an orientation in which its eyepieces 26 are positioned near the front wall 16. The imaging system 25 can comprise substantially any imaging system that can be used to image materials at hyperbaric pressures. In some embodiments, the imaging system 25 comprises a hybrid imaging system that includes an AFM+fluorescence microscope. In some embodiments, the interior space formed by the body 14 is large enough to house not only most commercially-available hybrid imaging systems, but also confocal microscopy attachments and additional equipment for various applications (e.g., electrophysiology, amperometry).

With continued reference to FIG. 1, the rear end of the body 14 is enclosed by a rear wall 26. In the illustrated embodiment, the rear wall 26 is convex so as to extend outward from the rear end of the body 14. As is further shown in FIG. 1, a rear hatch door 28 is mounted to the rear wall 28 that enables users to access the interior space from the rear, for example when the body 14 is secured to the front wall 16. By way of example, the rear hatch door 24 is approximately 30 inches in diameter and is mounted on an interior swing arm mechanism (not visible in FIG. 1) that enables the door to swing inwardly into the interior space when the door is opened. The rear hatch door 24 is configured to seal to the rear wall 22 from within the interior space when the chamber 10 is pressurized.

In the illustrated embodiment, the front wall 16 is formed as a generally flat, circular plate. By way of example, the front wall 16 can be made of approximately two-inch thick steel. An opening 30 is formed through the front wall 16 that can be closed with a front hatch door 32. In some embodiments, the front hatch door 32 can have a diameter of approximately 22 inches. As shown in FIG. 1, the front hatch door 32 can include a window 34 that enables users to see into the interior space of the chamber 12 when the door is closed.

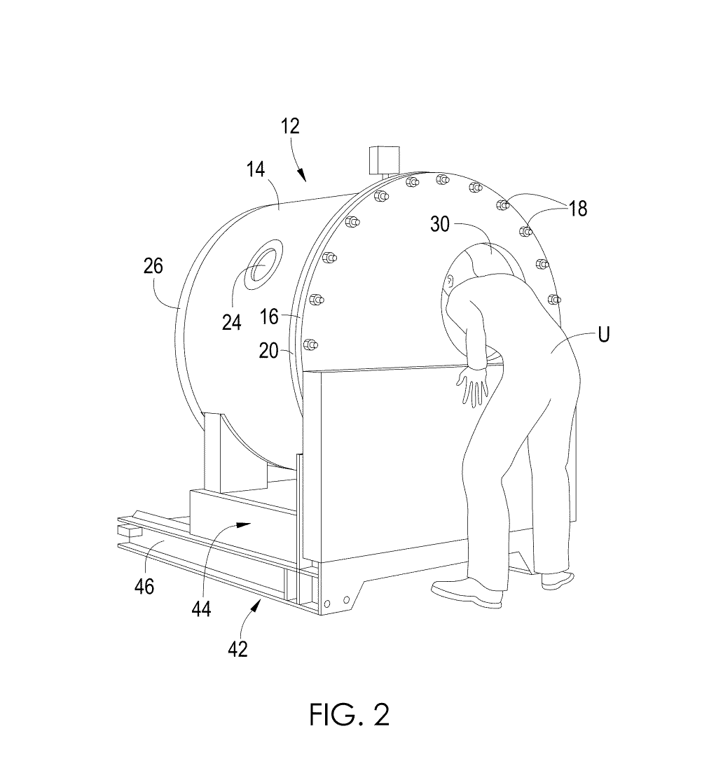

As is also shown in FIG. 1, the front hatch door 32 is mounted to the inside of front wall 14 with a linear track mechanism 36 that enables the door to laterally slide along the inside of the front wall to provide access to the interior space. In similar manner to the rear hatch door 28, the front hatch door 32 seals to the inside of the front wall 16 when the chamber 12 is pressurized. In some embodiments, the front hatch door 32 is displaced a small distance away from the inner surface of the front wall 16 by the track mechanism 36 when it is opened so that the door can be slid laterally along the front wall without contact it. As is depicted in FIG. 2, a user, U, can gain access to the interior space of the chamber 12 through the opening 30 when the front hatch door 32 has been opened. Because of the position of the eyepieces 26 of the imaging system 25 (FIG. 1), such a user can also directly view materials with the imaging system under atmospheric conditions via the opening 30.

With further reference to FIG. 1, a support platform 38 is provided within the interior space of the chamber 10 that is used to support the imaging system 25. In the illustrated embodiment, the support platform 38 is mounted to the front wall 16 in a cantilevered configuration and does not make any contact with the body 14 or any other part of the chamber 12. With such a configuration, vibration from movement of the body 14 is not directly transmitted to the imaging equipment 25. As is also shown in the figure, a vibration isolation table 40 can be positioned between the imaging system 25 and the support platform 38 to further reduce transmission of vibration to the imaging system.

Both the body 12 and the front wall 14 are supported by a frame 42. The front wall 16 is fixedly mounted to the frame 42 in a manner in which the front wall cannot move relative to the frame. The body 14, however, is supported by a carriage 44 that can roll or slide along parallel rails 46 of frame 38 that are positioned on the floor. With such a configuration, the body 14 can be moved away from the front wall 16 along the rails 46 when the body is not secured to the front wall (see FIG. 1). In some embodiments, the body 14 can be moved approximately 31 inches away from the front wall 16 to provide ample access to the interior space and all the components contained therein, including the imaging system 25. The frame 42 can be supported by vibration pads (not shown) that absorb vibrations that propagate through the floor on which the chamber 12 rests to further reduce vibration that can disturb the imaging equipment 25.

Referring next to FIG. 3, various ports 50 can be provided through the body 14 of the chamber 12 for electrical, gas, and fluid delivery and for receiving data (e.g., image data) collected from within the chamber. The electrical lines can be used to power the imaging system 25 as well as heating and/or cooling equipment that can be provided within the chamber 12. The gas lines can be used to deliver desired gases to the interior space. The fluid lines can be used to deliver fluid to the cooling system provided within the chamber.

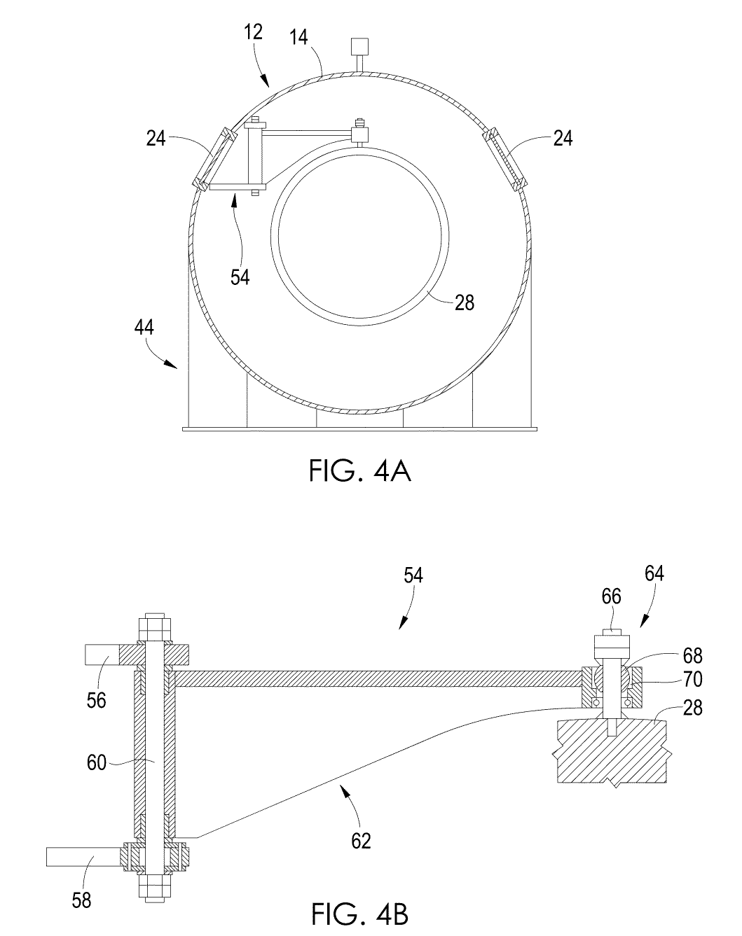

FIGS. 4A and 4B illustrate an example configuration for mounting of the rear hatch door 28. As is shown in FIG. 4A, the rear hatch door 28 can be supported by a swing arm mechanism 54 that is mounted to the wall of the body 14 of the chamber 12. As is shown in the detail view of FIG. 4B, the mechanism 54 includes mounting brackets 56 and 58 that mount to the body 14. The brackets 56, 58 support a pivot shaft 60 to which is mounted a swing arm 62 that extends outward from the shaft and that can pivot about or with the shaft. Provided at a distal end of the swing arm 62 is a door mounting element 64 that is adapted to mount the rear hatch door 28 to the arm. In the embodiment of FIG. 4B, the mounting element 64 includes a fastener 66 that extends through a ball 68 that is contained by a socket 70 formed at the end of the swing arm 62. With such a configuration, the rear hatch door 28 can swivel and rotate with respect to the swing arm 62 so that the door can be moved out of the way when it is opened to provide easy access to the chamber interior space.

The design of the above-described system 10 is particularly advantageous for imaging of materials at hyperbaric pressures and the equipment and conditions required to conduct such imaging. One unique aspect of the system 10 is the manner in which it can be accessed. Specifically, the interior space of the chamber 12 can be accessed using the front hatch door 32, the rear hatch door 28, or by sliding the body 14 away from the front wall 16. Accordingly, there are three different modes of accessing the interior of the chamber 12. In some embodiments, the front hatch door 32 can be used to gain quick or routine access to the interior space (see FIG. 2), the rear hatch door 28 can be used to conduct routine maintenance or adjustment of the equipment within the chamber 12, and opening of the chamber by sliding the body 14 can be used to conduct maintenance, adjustment, or replacement of the imaging system 25. These different modes of access are particularly useful in the hyperbaric imaging context. In addition to enabling imaging of materials under hyperbaric conditions, the hyperbaric chamber 12 also can significantly reduce noise levels that could otherwise hinder clear imaging.

A system having features similar to those described above was constructed and installed at the Hyperbaric Biomedical Research Laboratory (HBRL) at the University of South Florida (USF) at Tampa. The chamber was hydrostatically pressure tested (1.5× MWP), and then transported from the factory to the HBRL. Approximately two years of equipment installation, testing, and refinement were used to develop the integrated hyperbaric AFM and fluorescence microscopy imaging station.

Design characteristics that were considered for the hyperbaric imaging system included the ability to use live cell preparations, the ease of use under ambient conditions, thermoregulation to counteract pressure effects on temperature, and full control of existing microscope features at hyperbaric pressures. The imaging system allows for AFM and fluorescence measurements during compression and decompression. A limitation of the hyperbaric imaging system includes thermal changes with rapid compression and decompression, especially with thermally conductive inert gases (e.g., He). The maximum working pressure of the chamber is limited to 85 psig, which is zero referenced against ambient air pressure. Therefore, approximately 6.8 atmospheres absolute (ATA) can be studied, which encompasses pressures most commonly experienced in dive operations and dive-related illnesses including CNS O₂ toxicity (≧2 ATA O₂), N₂ narcosis (≧4 ATA air), or CO₂ toxicity (>0.1 ATA CO₂).

Prior to initiating the project, the microscope manufacturers (Bruker and Nikon) were consulted to determine whether its technology would withstand hyperbaric pressure. Engineers at both companies confirmed that there were no pressure-sensitive components, but they could not guarantee that various hyperbaric gases would not damage the equipment (e.g., gas-tight sealed components), alter the operating characteristics, or reduce image resolution. Those factors were taken into consideration and the installation and testing of equipment under hyperbaric pressure were cautiously performed.

Effective vibration isolation and noise reduction is essential for high-resolution data with AFM and fluorescence microscopy. Several approaches were used to dampen mechanical and acoustic noise to extend the high-resolution capabilities of the hyperbaric imaging system. The weight of the chamber (3.25 tons) provides some vibration dampening from the floor. To further reduce chamber vibration, four 40 millimeter (mm) vibration isolation pads (Micro/Level Isolator, 8iM26; Vibro/Dynamics) were positioned underneath the four corners of the chamber. In addition, a mechanically-geared, low-frequency vibration isolation table (Minus K; Novascan) was positioned inside the chamber on the cantilevered support platform. That isolation table is ideally suited for AFMs and allows for noise levels below 0.1 nanometers (nm). Importantly, the Minus K has no sealed components that could potentially alter its function under hyperbaric pressure, which is a problem with conventional air tables and vibration isolation foam. AFM is not only sensitive to mechanical transmission of noise through solid surfaces, but also through transmission of acoustical waves. Auditory vibrations from equipment and air flow inside the chamber were dampened by installing fire-resistant acoustic foam (ASTM E84 standard) to the internal surfaces of the chamber. In addition, ceiling air vents over the chamber were closed and redirected away from the chamber to minimize any source of external noise. These modifications have made the chamber itself function as a vibration-isolated acoustic hood system and have improved the signal-to-noise ratio.

The thermal fluctuations in response to compression and decompression of N₂ and He were assessed and a significant increase in temperature (>10° C.) with a rate of compression greater than 2 pounds per square inch per minute (psi/min) over 30 minutes was observed. To prevent a pressure-related increase or decrease in chamber ambient temperature, a circulating water chiller (Fisher IsoTemp 3028 s) and circulating water heater (Lauda Model M20) were installed. Both circulating water baths were plumbed into the chamber and connected to a radiator/fan system. The cooling system allows for enhanced thermal stability when rates of compression are increased greater than 2 psi/min. The temperature regulation system was used, because many biological processes are expected to be sensitive to faster rates of compression and decompression, and because AFM performance is temperature sensitive. The pressure versus temperature relationship varies depending on what gas is used for compression. Helium, for example, has a thermal conductivity of 360.36 CalIT s-1 cm-1 oC-1, whereas O₂, N₂, and air all have lower thermal conductivity within the narrow range of 60 to 64 CalIT s-1 cm-1 oC-1. The high thermal conductivity of He makes this gas more likely to perturb AFM stability during rapid changes in pressure, but this property makes it useful in testing countermeasures to maintain thermal stability during compression and decompression. In addition, He is very unique from a biological perspective because of its very low lipid solubility, which makes it useful to study the biological effects of pressure per se independently of the anesthetic effects of N₂ or oxidative effects of O₂, and it thus can be used to mimic true hydrostatic compression.

A Bioscope SZ imaging system was installed within the hyperbaric chamber that comprised an inverted biological microscope (Nikon TE2000E) mated with an AFM (Bruker Instruments, Santa Barbara, Calif.). Following the installation of the imaging system, the next phase of development was the installation of the electrical penetrations, fluid penetrations, and gas penetrations. Electrical penetrations were installed through the wall of the chamber to power a variety of equipment. Additional penetrations were installed for electrophysiology and amperometry equipment to ensure that these capabilities existed for future applications. Installation of electrical penetrations required additional cables from manufacturers (Bruker Instruments, Nikon Inc). These cables were cut and modified with the appropriate D-connectors for connecting to electrical boxes on the interior and exterior of the chamber. In addition to powering the AFM and fluorescence microscope, electrical penetrations were made for accessories including a camera and radiator fan. An additional electrical power source was provided by installing a surge-protected power supply with a custom-made epoxy-embedded electrical penetration. Penetrations were installed for an analog gauge pressure sensor, digital pressure sensor, oxygen sensor, chamber exhaust and intake, fluid lines for a chilled water bath and heated water bath, a pressure relief valve (85 psig), and a liquid light guide.

To minimize potential damage to the expensive components involved, a conservative approach was taken to pressurizing the imaging system. The chamber was first pressurized without the AFM scan head to assess the function of the Nikon TE 2000E and associated equipment at hyperbaric pressure, including the remote-controlled adjustment of fine focus and microscope objectives. The first pressurization was with 100% N₂. During this experiment, the pressure was slowly raised (1 psi/min) and a steady rise in temperature was continuously observed. Temperature regulation is an important consideration and a potential limitation for the rate of pressurization because thermal fluctuations can potentially influence AFM resolution and biological preparations.

After it was confirmed that all imaging equipment and associated electrical components worked at greater than 60 psig N₂, the experiment was repeated with He.

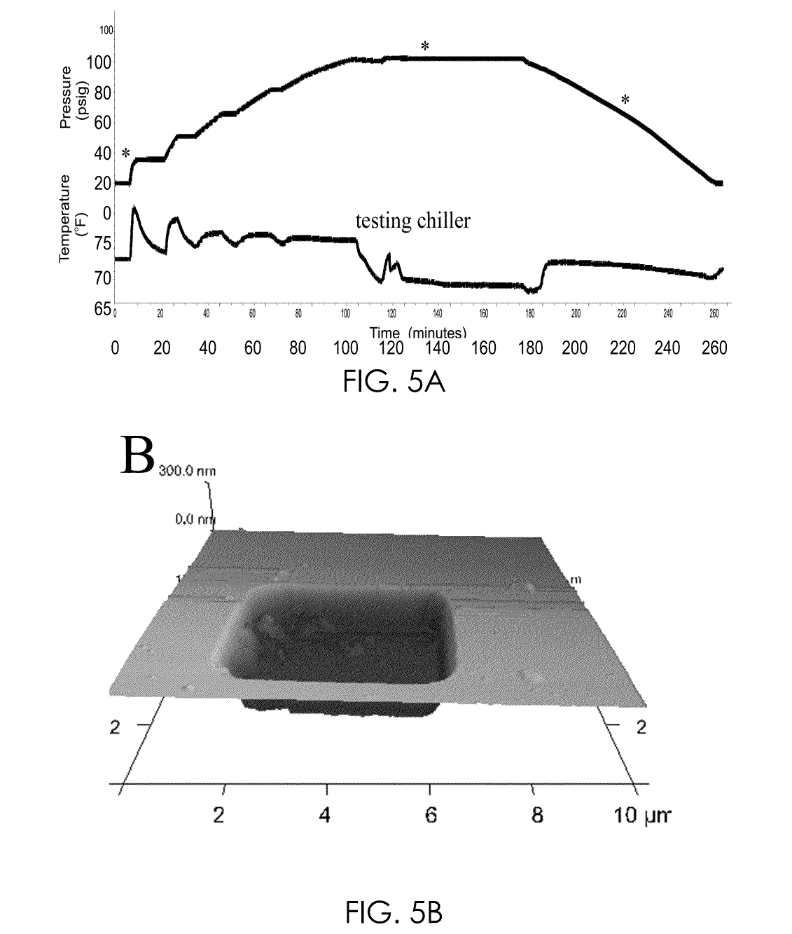

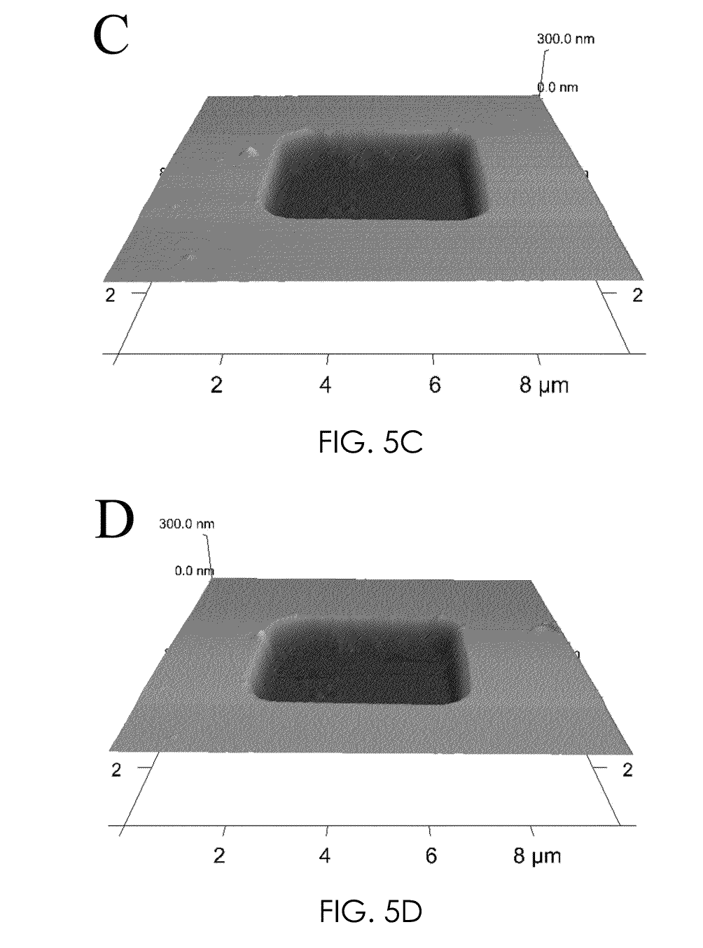

There are two potential problems with using He for pressurization: its thermally conductivity and its potential to damage equipment by crossing barriers of sealed components. To confirm that the imaging system functions properly in the presence of hyperbaric He, the chamber was pressurized to the maximum working pressure (85 psig) and held for over one hour while testing the operating characteristics of the AFM. No malfunctions were observed. However, in other experiments it was observed that He caused significant changes in chamber temperature proportional to rates of pressurization, as shown in FIG. 5A. Scans were made at graded levels of pressurization to assess AFM operating characteristics during rapid compression, at hyperbaric pressure, and during decompression. Rapid compression with He (5 psi/min) added significant noise (scanning artifacts), as indicated in FIG. 5B, which was likely due to thermal changes and air turbulence. Stable scans could be made under pressure and during gradual decompression (1 psi/min), as indicated in FIGS. 5C and 5D. Following these experiments, a series of tests were performed to adjust the temperature regulation system to minimize temperature fluctuations during compression and decompression.

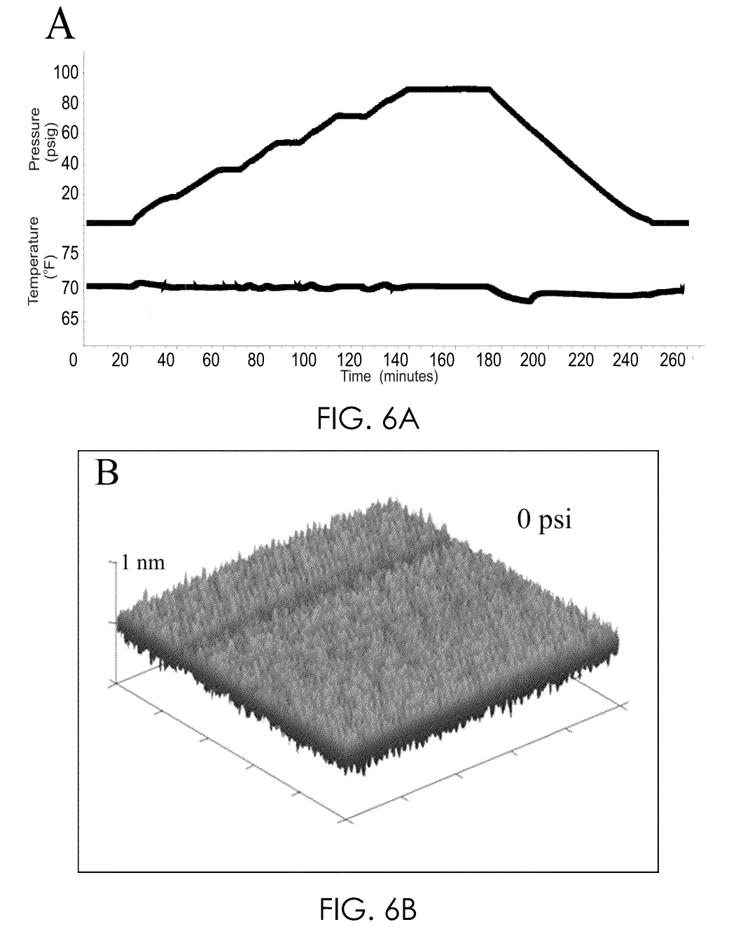

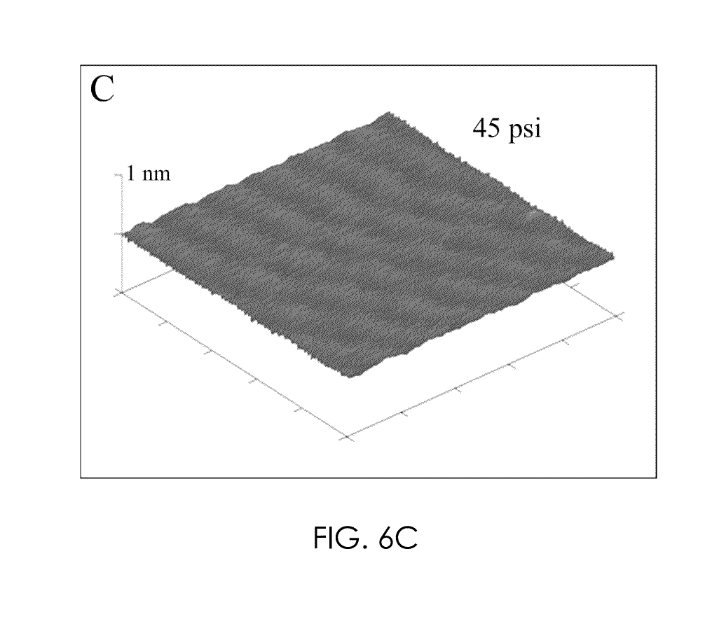

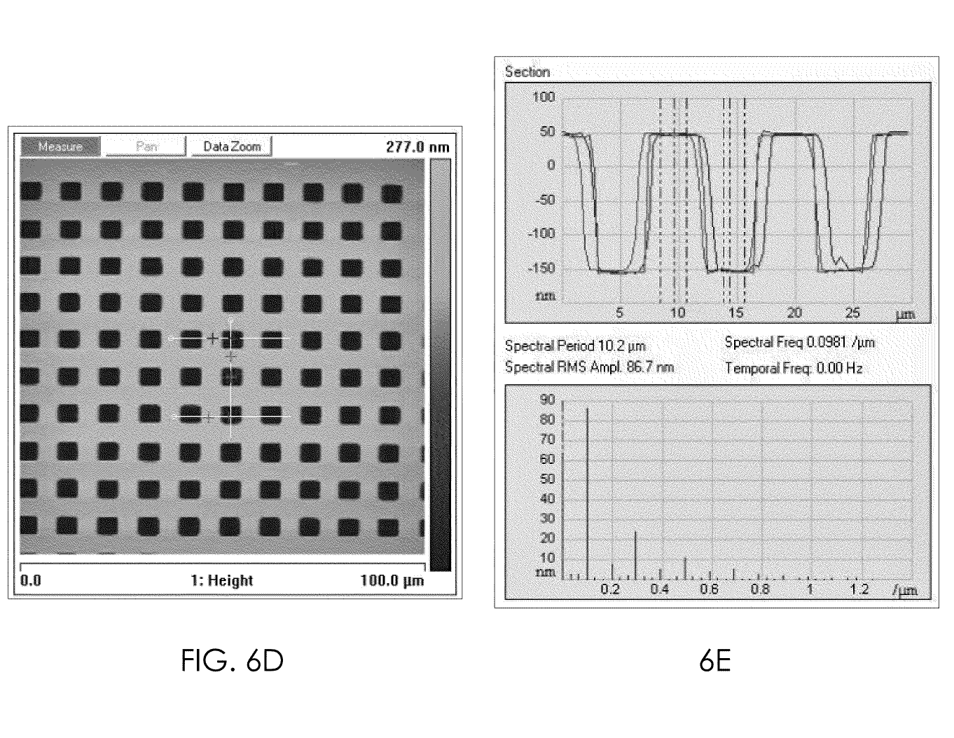

AFM testing at hyperbaric pressure was performed using dry and fluid scans, in both contact and tapping mode. A representative example of a pressure verses temperature relationship (with thermoregulation system operating) and corresponding noise tests is shown in FIG. 6. AFM system noise (in nm) at hyperbaric pressure (N₂, He, and air) consistently averaged proximately 0.08, 0.04, 0.04, 0.03, 0.05, 0.08 at 0, 15, 30, 45, 60, and 75 psig, respectively. Less noise was observed at approximately 45 psig, as shown in the comparison of representative scans in FIGS. 6B and 6C. Changes in cantilever resonance frequency and Q factors were observed under hyperbaric pressure, although this did not impair AFM resolution or noise measurements. Subnanometer vertical resolution was achieved when scanning at maximum working pressure (85 psig), as shown with section analysis of three calibration pits (FIG. 6D). One unexpected observation was a displacement of the laser spot on the photodetector with a change in pressure, but this was not consistent. There was also a decrease in sum signal at hyperbaric pressure (˜4.60 V to ˜2.85 V), but this did not have any observable effect on image resolution or AFM performance.

The hyperbaric AFM and fluorescence microscopy was tested on a variety of cell culture preparations, including primary rat hippocampal neurons and human fibroblast cells. Cultures were treated with a range of hyperbaric gases at pressures up to 85 psig for 60 minutes in a CO₂-independent buffered medium, which eliminated the need to control for changes in CO₂/pH during HBO₂ exposure. Morphological changes were observed in hippocampal neurons exposed to HBO₂ (4 ATA O₂). Neuronal processes provide an ideal target for AFM analysis because they are considerably more resistant to movement artifacts when compared to cell bodies and the morphology of neuronal processes provides a sensitive index of cell viability, cellular response to stimuli, and changes in cell volume.

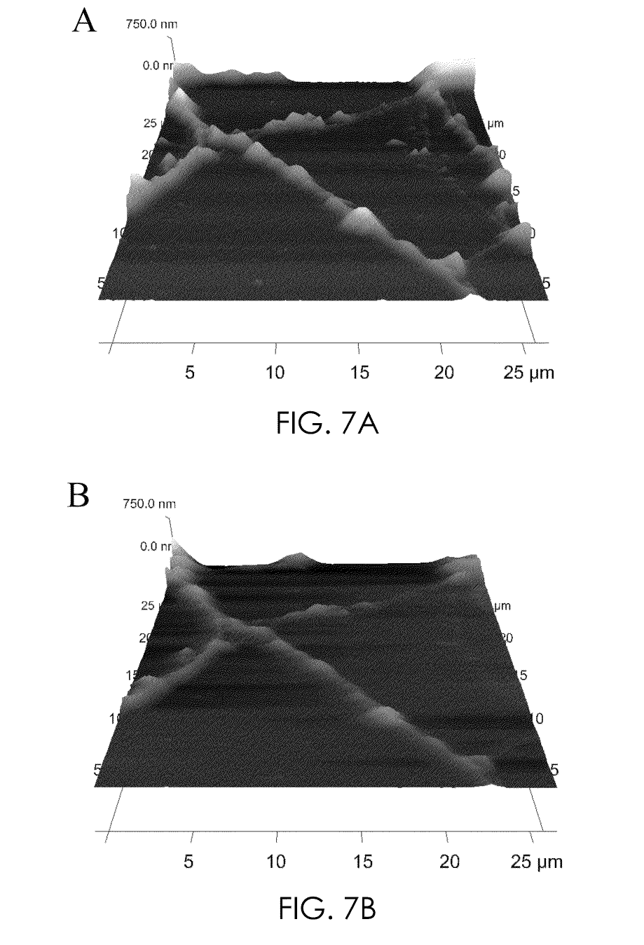

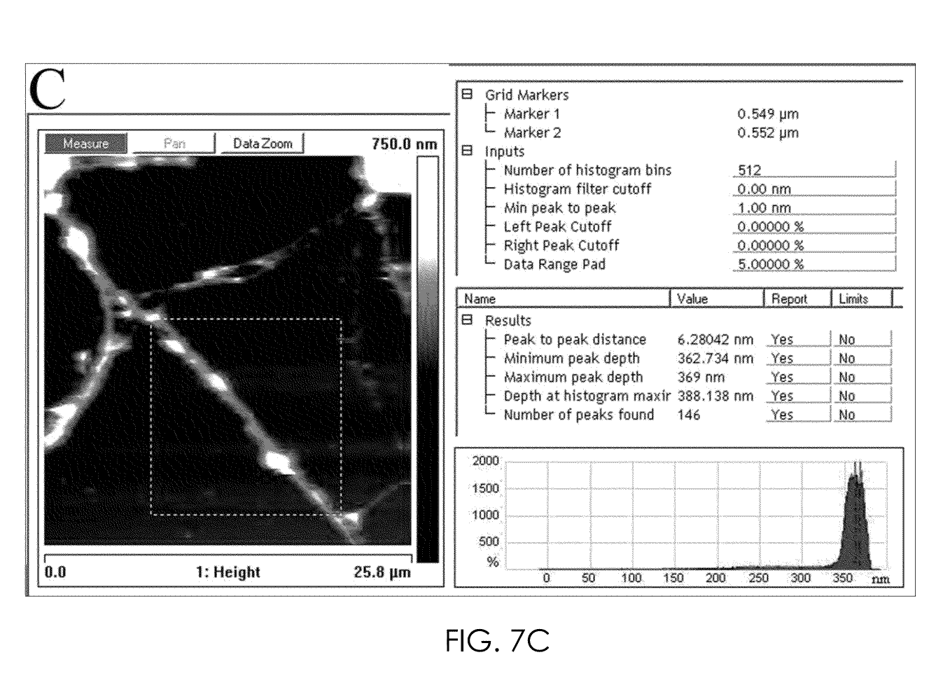

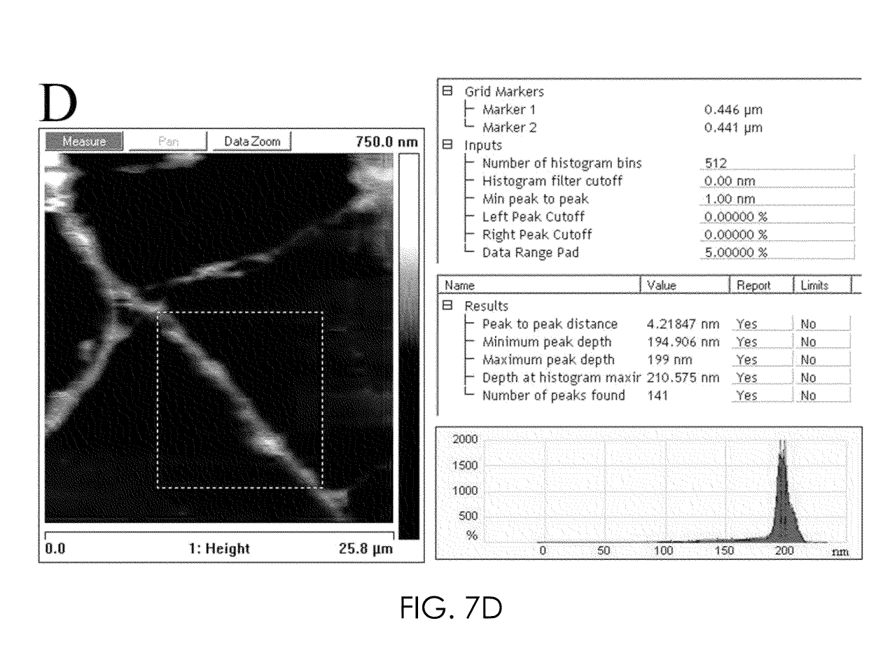

FIG. 7 shows an example of neuronal processes imaged in tapping mode and maintained under control conditions and during exposure to solutions that were equilibrated with 4 ATA O₂ in HPLC sample cylinders. Rapid (˜15 min) and significant morphological changes in cells exposed to 4 ATA O₂ were observed. Using a section and histogram analysis, it was observed that the average peak height of the neuronal processes was approximately 350 nm in control and 200 nm in 4 ATA O₂, as shown in FIGS. 7C and 7D. Similar results were seen using “pseudo-HBO₂”, which involves exposure to hyperoxic superfusate without an increase in barometric pressure, suggesting that these results were due to an oxygen-induced increase in ROS production and not the effects of pressure per se.

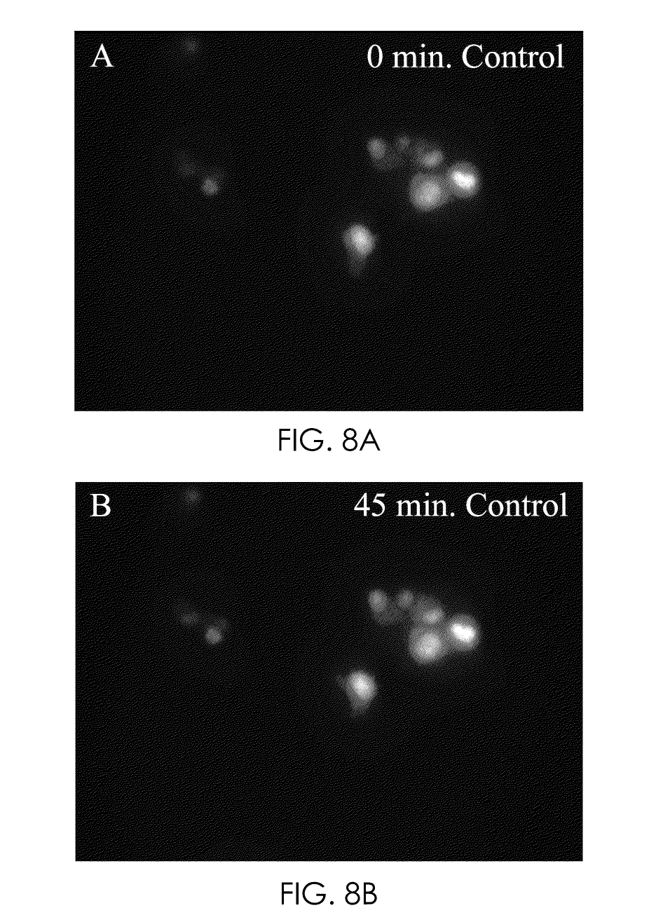

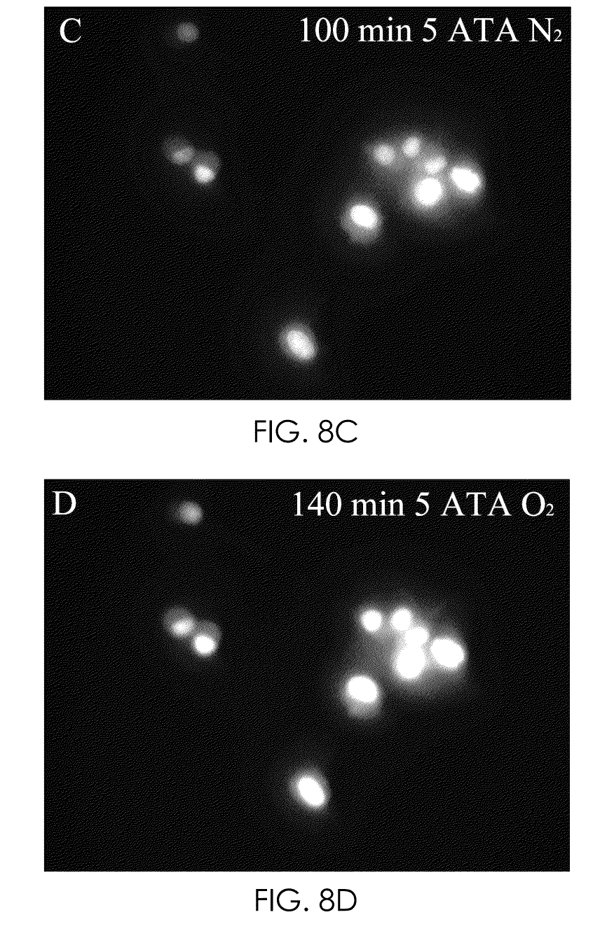

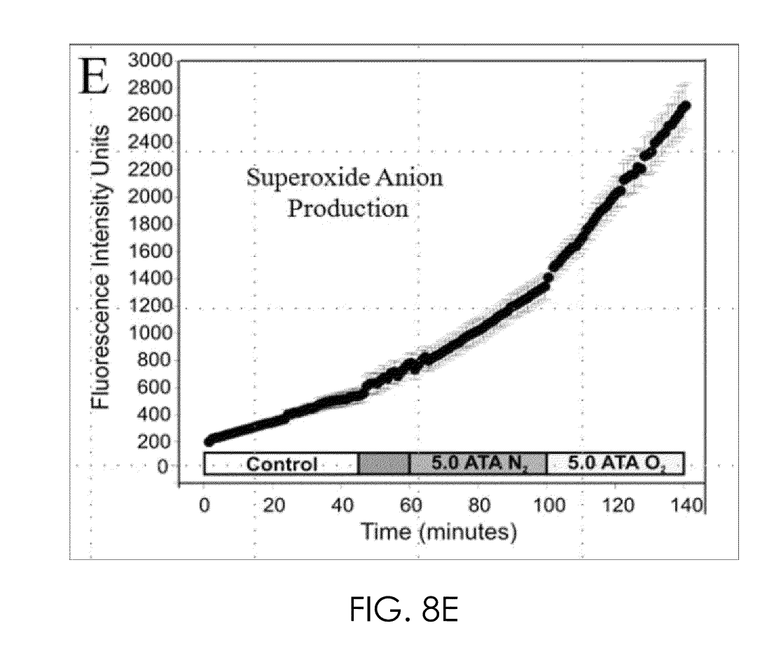

Performing hyperbaric fluorescence microscopy allowed for real-time visualization of intracellular processes reflecting changes in cellular metabolism (e.g., superoxide production) in response to hyperbaric gases. FIG. 8 shows hyperbaric fluorescence microscopy imaging of intracellular superoxide anion production in human U87 glioma cells. Measurements were taken under control conditions in air to assess the baseline level of superoxide production (FIGS. 8A and 8B). Following baseline measurements the chamber was pressurized with 5 ATA N₂ (FIG. 8C) and the production of superoxide was tracked in 10 cells. The cells were then superfused with solution equilibrated hyperbaric oxygen (5 ATA O₂) (FIG. 8D). Note the time-dependent increase in superoxide production in response to hyperoxia. FIG. 8E shows summary data from three experiments depicting superoxide production in air relative to hyperbaric N₂ and HBO₂.

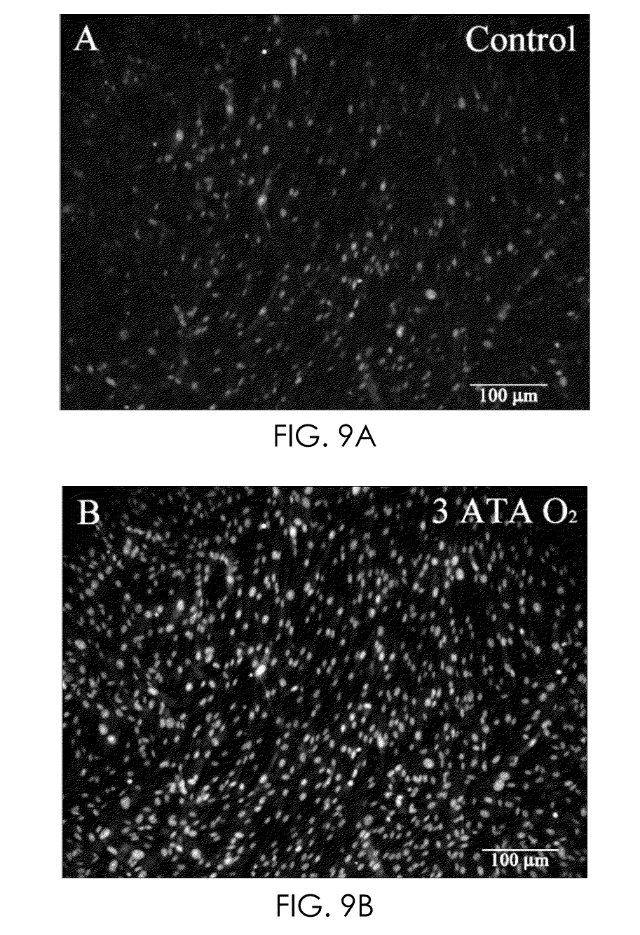

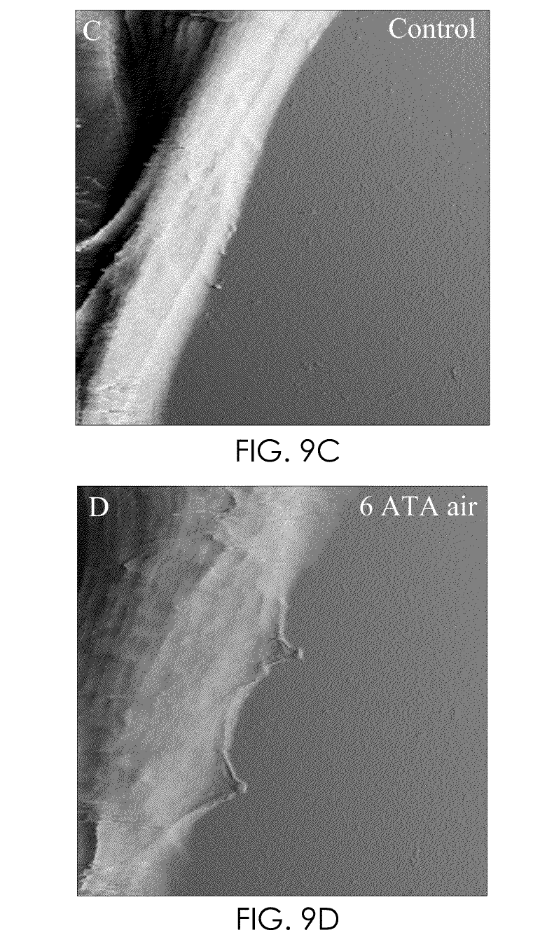

Hyperbaric fluorescence microscopy measurements confirmed that the cellular response to hyperbaric gases alters the redox state of this cellular model of malignant brain cancer, which may explain the hyperoxia-induced membrane lipid peroxidation reported in a previous AFM study. Hyperbaric AFM and fluorescence microscopy was performed on human fibroblast cells. The fluorescence photomicrographs in FIGS. 9A and 9B depict superoxide production in response to 3 ATA O₂ and the effects of hyperbaric air (6 ATA) on fibroblast morphology. A representative image of an AFM scan in contact mode shows fibroblasts exposed to control conditions (ambient air) (FIG. 9C) and then repeated on the same cell after pressurizing to 6 ATA air (FIG. 9D). Note the morphological changes and the actin-rich plasma membrane protrusions (filopodia) on the edge of the cell. Filopodia play an important role in response to stimuli, including cell migration and wound healing.

As described above, an integrated system for hyperbaric AFM and fluorescent imaging of biological preparations, including living cells, has been developed and tested. The current system and future adaptations will provide insight into the fundamental molecular and biochemical mechanisms underlying CNS O₂ toxicity (hyperoxia-induced oxidative stress), baro-related disorders of CNS function, and potential therapeutic effects of HBO₂ therapy (e.g., would healing and cancer treatment). Another application of this technology is to characterize the effects of narcotic gases on cells, especially on the properties of the plasma membrane. The narcotic potency of gases is reportedly proportional to the lipid solubility of the gas, and thus this relationship can be tested by measuring membrane visco-elasticity in response to a range of gases at hyperbaric pressures. The use of this technology is relevant for our understanding of neurophysiological problems encountered in diving, aerospace physiology/medicine, and hyperbaric biomedical field.

Although the chamber disclosed herein has been described as being a “hyperbaric” chamber and has been described as facilitating imaging under hyperbaric conditions, it is noted that the chamber could easily be modified to create hypobaric conditions. In some cases, such a modification would entail reversing the mounting schemes for the doors and windows so that negative pressure (vacuum) would seal the doors and windows instead of positive pressure.

1. A system for performing microscopy at hyperbaric pressures, the system comprising:
a hyperbaric chamber that defines a sealed interior space; and
an imaging system contained within the interior space that is operated from outside of the hyperbaric chamber to image materials within the interior space at hyperbaric pressures.

2. The system of claim 1, wherein the hyperbaric pressures are within approximately 0.1 to 85 pounds per square inch gauge (psig).

3. The system of claim 1, wherein the hyperbaric chamber comprises a movable body and a fixed front wall and wherein the body can be moved away from the front wall to provide access to the interior space.

4. The system of claim 3, wherein the hyperbaric chamber comprise a support platform within the chamber on which the imaging system is supported, the support platform being mounted to the front wall but not making contact with any other component of the chamber.

5. The system of claim 4, further comprising a vibration table positioned between the support platform and the imaging system.

6. The system of claim 3, wherein the hyperbaric chamber is supported by a frame that includes parallel rails along which the body can roll or slide.

7. The system of claim 1, wherein the hyperbaric chamber comprises a front hatch door through which the interior space can be accessed, the door being adapted to open inward into the interior space.

8. The system of claim 7, wherein the front hatch door is mounted to an inside wall of the chamber with a linear track mechanism with which the door can be slid within the chamber to provide access to the interior space.

9. The system of claim 1, wherein the hyperbaric chamber comprises a rear hatch door through which the interior space can be accessed, the door being adapted to open inward into the interior space.

10. The system of claim 9, wherein the rear hatch door is mounted to an inside wall of the chamber with a swing arm mechanism with which the door can be swung into the chamber to provide access to interior space.

11. The system of claim 1, wherein the hyperbaric chamber comprises multiple ports through which electricity, fluids, or data can pass into or out of the chamber.

12. The system of claim 1, wherein the imaging system comprises an atomic force microscope (AFM).

13. The system of claim 1, wherein the imaging system comprises a hybrid atomic force microscope (AFM)+florescence microscope.

14. The system of claim 1, further comprising vibration pads upon which wherein the hyperbaric chamber is supported.

15. A system for performing microscopy at hyperbaric pressures, the system comprising:
a hyperbaric chamber that defines a sealed interior space, the hyperbaric chamber comprising:
a body and a front wall, wherein the body can be moved away from the front wall to provide access to the interior space,
a support platform mounted to the front wall within the chamber but not making contact with any other component of the chamber,
a front hatch door provided in the front wall through which the interior space can be accessed, the door being adapted to open inward into the chamber,
a rear hatch door provided in the body through which the interior space can be accessed, the door being adapted to open inward into the chamber,
ports through which electricity, fluids, or data can pass into or out of the chamber; and
an imaging system provided within the interior space and supported by the support platform, the imaging system being operable from outside of the hyperbaric chamber to image materials within the interior space at hyperbaric pressures of approximately 0.1 to 85 pounds per square inch gauge (psig).

16. The system of claim 15, wherein the hyperbaric chamber is supported by a frame that includes parallel rails along which the body can roll or slide.

17. The system of claim 15, wherein the front hatch door is mounted to an inside wall of the chamber with a linear track mechanism with which the front hatch door can be slid within the chamber to provide access to the interior space.

18. The system of claim 15, wherein the rear hatch door is mounted to an inside wall of the chamber with a swing arm mechanism with which the rear hatch door can be swung into the chamber to provide access to interior space.

19. The system of claim 15, wherein the imaging system comprises a hybrid atomic force microscope (AFM)+florescence microscope.

20. The system of claim 15, further comprising vibration pads upon which wherein the hyperbaric chamber is supported.

21. A method for imaging materials at hyperbaric pressures, the method comprising:
placing an imaging system within a hyperbaric chamber;
placing material to be imaged on the imaging equipment;
pressurizing the hyperbaric chamber to an elevated pressure; and
controlling the imaging equipment from outside of the hyperbaric chamber to obtain images of the material.

22. The method of claim 21, wherein the imaging system comprises an atomic force microscope.

23. The method of claim 21, wherein the imaging system comprises a hybrid atomic force microscope (AFM)+florescence microscope.
